(19) United States
(12) Patent Application Publication
(10) Pub. No.: US 2005/0266795 A1
(43) Pub. Date: Dec. 1, 2005

(54) [METHOD OF COMMUNICATION USING AUDIO/VIDEO DATA]

(76) Inventors: Chengshing Lai, Taipei County (TW); Hong Ding, Nanking (CN); Yongqian Gu, Nanking (CN)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,738

(22) Filed: May 26, 2004

(51) Int. Cl. H04Q 7/20

(52) U.S. Cl. 455/3.05

(57) ABSTRACT

A method of transmitting and receiving an audio/video data, and a method of communication between a first mobile communication apparatus and a second mobile communication apparatus using audio/video data are provided. An audio/video data to be transmitted is selected via the first mobile communication apparatus. Next, the audio/video data is transformed into at least one data packet via the first mobile communication apparatus based on a permitted data flow specified by PHS. Next, the packet data is transmitted via the first communication apparatus. Thereafter, the data packet is received via the second mobile communication apparatus where the data packet is transformed into the audio/video data.

### BACKGROUND OF INVENTION

1. Field of the Invention

The present invention relates to a method of communicating an audio/video data, and more particularly, to a method of communicating an audio/video data via a mobile communication apparatus under personal handyphone system (PHS).

2. Description of Related Art

In the present information era, communication between people via electronic communicative apparatuses is increasingly popular, especially via mobile apparatuses, for example mobile telephones or electronic apparatuses equipped with wireless communication function. Therefore, electronic communication has become a part of our daily life ever since. A mobile communication apparatus does not operate without a mobile communication system, and presently, two major mobile communication systems, namely Group Special Mobile (GSM) and Personal Handyphone System (PHS) are available.

Most communication apparatuses operated by GSM system manage to send messages, which may contain text, voice, image, and video files. However, those operated by PHS system is capable of sending regular text message, whereas audio/video files carrying voice, image and video files cannot be sent via the PHS system. For example, when a specific ringer signal of another users mobile communication apparatus is desired, the only way is to retrieve the ringer signal from another users apparatus is to re-input the code of the specific ring signal designated communicating apparatus, where the communication apparatuses are operated under PHS system.

Since a lot of PHS communication apparatuses are being desirably accepted among young customers, accordingly transmission of audio/video files via/between communication apparatuses are highly desired. However, since the current PHS and communication apparatuses thereof do not have the foregoing desirable functionality, those communication apparatuses operated under PHS are cannot be acceptable to young customers compared to those operated by GSM.

### SUMMARY OF INVENTION

The present invention is directed to a method of transmitting an audio/video data using a mobile communication apparatus operated under the personal handyphone system (PHS).

The present invention is also directed to a method of receiving an audio/video data using a mobile communication apparatus operated under the personal handyphone system (PHS).

The present invention is also directed to a method of communication between mobile communication apparatuses operated under the personal handyphone system (PHS) using audio/video data.

According to an embodiment of the present invention, an audio/video data to be transmitted is selected. The audio/video data is then transformed into at least a data packet based on permitted data flow specified by the PHS system. Thereafter, the data packet is transmitted.

According to an embodiment of the present invention, after the communication apparatus receives a message, the message is determined whether or not it is a data packet. When the message is being identified as a data packet, is the message is then transformed into an audio/video data.

According to an embodiment of the present invention, in the audio/video data communication method between a first mobile communication apparatus and a second mobile communication apparatus using audio/video data, wherein the first and second mobile communication apparatuses with a PHS system. First, an audio/video data to be transmitted via the first mobile communicating apparatus is selected. The selected audio/video data is then transformed into at least a data packet based on a permitted data flow specified by the PHS system. The data packet is then transmitted. Afterwards, when the transmitted message is received by the second mobile communicating apparatus, and the data packet is transformed into the audio/video data.

According to an embodiment of the present invention, an audio/video data to be transmitted is first selected based upon a permitted data flow specified by PHS and the selected audio/video data is transformed into at least one data packet, and then the data packet is transmitted. The data packet is then received by another mobile communication apparatus operated under PHS and is rearranged before being examined for completeness thereof. In other words, an audio/video data can be freely transmitted, received, and the audio/video data can be used for communication between mobile communication apparatuses complying with PHS.

### BRIEF DESCRIPTION OF DRAWINGS

FIG. 1 is a schematic flow chart illustrating a method of transmitting an audio/video (A/V) data according to an embodiment of the present invention.

FIG. 2 is a schematic flow chart illustrating a method of receiving an audio/video (A/V) data according to an embodiment of the present invention.

### DETAILED DESCRIPTION

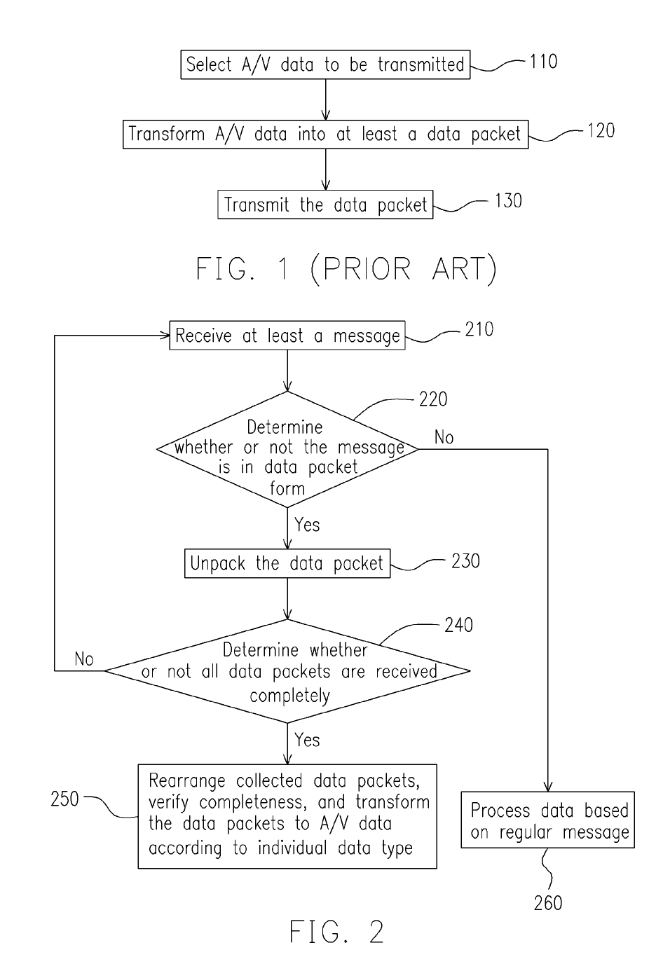

FIG. 1, a schematic flow chart illustrating a method of transmitting an audio/video data according to an embodiment of the present invention. In step 110, an audio/video data, such as sound, image, or video data format, to be transmitted is selected via a mobile communicating apparatus. Then in step 120, the audio/video data is transformed into at least one data packet based on a permitted data flow specified by PHS. Afterwards, the data packet is indirectly transmitted via the mobile communicating apparatus operated by a mobile communication switchboard as shown in step 130.

FIG. 2, is a schematic diagram of a flow chart illustrating a method of receiving an audio/video data according to an embodiment of the present invention. In step 210, at least a message, for example, from a mobile communication switchboard, is received by a mobile communication apparatus. In the following step 220, whether or not the message is a data packet is determined. If the message is identified to be a data packet, the method proceeds to step 230 where the data packet is unpacked by the mobile communication apparatus. If the message is not a packet data, the method proceeds to step 260, where the message is processed similar to a regular text message. Thereafter in step 240, whether or not the data packet received is complete is determined. If not complete yet, the method returns to step 210 where the mobile communication apparatus listens whether the message has been completely received or whether all of the data packets have been received. If the data packet or all data packets are completely received, the method proceeds to step 250 where all of the received data packets are rearranged therein and reexamined completeness thereof. The data packets are thus transformed to an audio/video data corresponding to a data format thereof, and are stored into an audio/video database associated with the mobile communication apparatus.

According to an embodiment of the present invention, a method of communication between a first and second mobile communication apparatuses using audio/video data utilizing the method the transmitting the audio/video data demonstrated in FIG. 1 the method of receiving the audio/video data demonstrated in FIG. 2 is provided. Both the first and second communication apparatuses comply with PHS system. First, an audio/video data to be transmitted is selected via the first mobile communication apparatus. Next, the selected audio/video data is transformed into at least a data packet based on a permitted flow specified by PHS. The data packet is then transmitted indirectly via a mobile communication switchboard, for example. Then the transmitted data packet is received by the second mobile communication apparatus and is transformed into the audio/video data.

In light of the above description, the method of communication using an audio/video data includes transforming an audio/video data to be transmitted into at least a data packet based on a permitted data flow specified by PHS system via a mobile communication apparatus, and then transmitting the data packet. Thereafter, the data packet is received by another mobile communication apparatus where the data packet is rearranged and verified for completeness before being transformed into the audio/video data. Therefore, an audio/video data can be freely transmitted, received, and transceived between mobile communication apparatuses complying with the PHS system, which greatly provide convenience to the mobile communication apparatus users.

Although the invention has been described with reference to a particular embodiment thereof, it will be apparent to those skilled in the art that modifications to the described embodiment may be made without departing from the spirit of the invention. Accordingly, the scope of the invention will be defined by the attached claims and not by the above detailed description.

1. An method of transmitting an audio/video data using a mobile communication apparatus complying with a personal handyphone system (PHS), the method comprising:
selecting an audio/video data to be transmitted;
transforming the audio/video data into at least one data packet based on a permitted data flow specified by PHS; and
transmitting the data packet.

2. The method as recited in claim 1, wherein the step of transmitting the data packet comprises transmitting the data packet through a mobile communication switchboard.

3. The method as recited in claim 1, wherein a format of the audio/video data is one selected from a group consisting of audio, image and video.

4. A method of receiving an audio/video data using a mobile communication apparatus complying with a personal handyphone system (PHS), the method comprising:
receiving at least one message data;
determining whether or not the message data is a data packet; and
wherein when the data message is the data packet, the data packet is transformed into an audio/video data.

5. The method as recited in claim 4 further comprising storing the audio/video data into an audio/video database associated with the mobile communication apparatus after the data packet is transformed into the audio/video data.

6. The method as recited in claim 4, wherein the message data is transmitted via a mobile communication switchboard.

7. The method as recited in claim 4, wherein a format of the audio/video data is one selected from a group consisting of audio, image and video.

8. A method of communication between a first mobile communication apparatus and a second mobile communicating apparatus using audio/video data, the first and second mobile communication apparatuses complying with a personal handyphone system (PHS), the method comprising:
selecting an audio/video data to be transmitted via the first mobile communication apparatus;
transforming the selected audio/video data into at least one data packet via the first mobile communication apparatus based on a permitted data flow specified by PHS;
transmitting the data packet via the first mobile communication apparatus;
receiving the data packet via the second mobile communication apparatus; and
transforming the data packet into the audio/video data via the second mobile communication apparatus.

9. The method as recited in claim 8, wherein the step of transmitting the data packet comprises transmitting the data packet via a mobile communication switchboard.

10. The method as recited in claim 8, wherein a format of the audio/video data comprises one selected from a group consisting of audio, image and video.

11. The method as recited in claim 8, wherein a format of the audio/video data comprises one selected from a group consisting of audio, image and video.
